(19) United States
(12) Patent Application Publication
(10) Pub. No.: US 2026/0218092 A1
(43) Pub. Date: Jul. 30, 2026

(54) GRANULAR LAUNDRY COMPOSITIONS CONTAINING DIPICOLINIC ACID AND METHODS OF MAKING THEREOF

(71) Applicant: THE PROCTER & GAMBLE COMPANY, Cincinnati, OH (US)

(72) Inventors: Linsey Sarah FULLER, Newcastle upon Tyne (GB); Joshua HAMPTON, Newcastle upon Tyne (GB); Andres Arturo MARTINEZ GUZMAN, Newcastle upon Tyne (GB)

(21) Appl. No.: 19/462,173

(22) Filed: Jan. 28, 2026

(30) Foreign Application Priority Data
Jan. 28, 2025 (EP) 25154463.1

(51) Int. Cl. C11D 17/06; C11D 1/22; C11D 1/83; C11D 3/10; C11D 3/12; C11D 3/28; C11D 3/37; C11D 11/00; C11D 11/02

(52) U.S. Cl. CPC C11D 17/06; C11D 1/22; C11D 1/83; C11D 3/10; C11D 3/122; C11D 3/1246; C11D 3/28; C11D 3/3761; C11D 11/0088; C11D 11/02; C11D 2111/12

(57) ABSTRACT

A granular laundry composition made from a surfactant and dipicolinic acid being co-formulated in the same particle. The composition can be used for laundering fabrics, in soft and hard water. The composition can be produced by: mixing dipicolinic acid, a surfactant and water to create a slurry; and drying the slurry to obtain a particle.

### FIELD OF THE INVENTION

The present invention relates to a granular laundry composition, a consumer product, a method of laundering fabrics and a method of making thereof.

### BACKGROUND OF THE INVENTION

It is well known that certain metal compounds, such as calcium and magnesium, increase the water hardness which can impact on negatively charged active detergent materials (e.g. anionic surfactants) resulting in loss of sudsing. Sudsing is important in distributing the active detergent material homogeneously across the fabric and therefore increasing the cleaning performance. Consumers also often associate the presence of suds as an indication of cleaning ability. If suds are not evident there is a tendency for consumers to frequently change the wash water and add more detergent which is unnecessary and wasteful.

Moreover, scale encrustation can readily form from hard water, for example on heating or pH change or evaporation. Scale encrustation can be found on the fabrics which are perceptible to the wearer as feeling harsh to the touch.

Organic dicarboxylic acids, such as dipicolinic acid or salts thereof, are known as biodegradable sequestering agents which are able to prevent encrustations on fabrics. It was also observed that, in hard surface cleaning detergents, dipicolinic acid coupled with surfactants and magnesium salts maintain suds stability in soft and hard water.

Whilst dipicolinic acid is known to provide a sudsing benefit in certain conditions, it is an object of the present invention to provide a granular laundry composition that contains dipicolinic acid and exhibits improved sudsing compared to other granular detergent compositions containing dipicolinic acid.

It is another object of the present invention to provide a consumer product comprising said granular laundry composition.

It is another object of the present invention to provide a method of laundering fabrics by using said granular laundry composition.

It is another object of the present invention to provide a method of making said granular laundry composition.

### SUMMARY OF THE INVENTION

We have surprisingly found that the co-formulation of a surfactant and dipicolinic acid or salts thereof in one particle provides enhanced sudsing compared to compositions in which the same ingredients are not formulated into the same particle.

The potential for dipicolinic acid or salts thereof to be produced through fermentation, combined with its biodegradability, positions it as an alternative to phosphonate-based sequestering agents, which are associated with significant environmental concerns.

In a first aspect, the present invention relates to a granular laundry composition comprising a surfactant and dipicolinic acid or salts thereof, wherein the composition comprises a first particle, characterized in that the first particle comprises the surfactant and dipicolinic acid or salts thereof.

In another aspect, the present invention relates to a consumer product comprising a package and the composition of the first aspect, wherein the package comprises at least one compartment, wherein the composition is contained in the at least one compartment.

In another aspect, the present invention relates to a process of laundering fabrics, said process comprising the steps of obtaining at least one fabric to be washed and a wash liquor; and bringing the at least one fabric and the wash liquor into contact with one another, wherein the wash liquor comprises a composition of the first aspect and water, wherein water has a hardness between 0° D and 28.77°D, preferably between 4.80° D and 19.18° D, more preferably between 6.71°D and 14.39° D.

In another aspect, the present invention relates to a process of making the composition of the first aspect, said process comprising the steps of: mixing dipicolinic acid, a surfactant and water to create a slurry; and drying the slurry to obtain a first particle.

### DETAILED DESCRIPTION OF THE INVENTION

The components, compositions, and processes of the present disclosure are described in more detail below.

As used herein, the articles “a” and “an” when used in a claim, are understood to mean one or more of what is claimed or described. As used herein, the terms “include,” “includes,” and “including” are meant to be non-limiting.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein the phrase “granular laundry composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Granular Laundry Compositions

The present invention relates to a granular laundry composition. The granular laundry composition can be understood to be a solid free-flowing particulate laundry composition or the granular laundry composition can be incorporated into a water-soluble unit dose article. The skilled person is aware of the characteristics of a solid free-flowing particulate laundry composition.

Typically, a water-soluble unit dose article comprises a water-soluble non-woven sheet, wherein: the non-woven sheet is shaped to create an internal compartment and the granular laundry composition is housed within said compartment; or the non-woven sheet is orientated into layers, the layers stacked on top of one another, and the granular laundry composition is positioned between said layers.

The water-soluble fibrous non-woven sheet comprises a plurality of fibers. Preferably, the fibers are inter-entangled fibers in the form of a fibrous structure. The water-soluble fibrous non-woven sheet may be homogeneous or may be layered. If layered, the water-soluble fibrous non-woven sheet may comprise at least two and/or at least three and/or at least four and/or at least five layers.

Preferably, the water-soluble fibrous non-woven sheet has a basis weight of between 20 gsm and 60 gsm, preferably between 20 gsm and 55 gsm, more preferably between 25 gsm and 50 gsm, most preferably between 25 gsm and 45 gsm. Those skilled in the art will be aware of methods to measure the basis weight.

By ‘fiber’ we herein mean an elongated element having a length exceeding its average diameter, preferably, a length to average diameter ratio of at least about 10. Preferably, each fiber may have a length of greater than or equal to 5.08 cm, greater than or equal to 7.62 cm, greater than or equal to 10.16, greater than or equal to 15.24 cm or a mixture thereof. Alternatively, each fiber may have length of less than 5.08 cm, less than 3.81 cm, less than 2.54 cm, or a mixture thereof. Each fiber may have a width of less than 100 μm, less than 75 μm, less than 50 μm, less than 25 μm, less than 10 μm, less than 5 μm, less than 1 μm or a mixture thereof. Those skilled in the art will be aware of standard methods and techniques to measure the width. Preferred methods include Scanning Electron Microscope (SEM) or an Optical Microscope together with image analysis software.

The water-soluble fibrous non-woven sheet may comprise a plurality of identical or substantially identical, from a compositional perspective, fibers. Alternatively, the water-soluble fibrous non-woven sheet may comprise two or more different fibers. Non-limiting examples of differences in the fibers may be physical differences such as differences in diameter, length, texture, shape, rigidness, elasticity, and the like; chemical differences such as crosslinking level, solubility, melting point, Tg, active agent. Preferably, the fibers are present between 80% and 95%, preferably between 85% and 93%, more preferably between 87% and 90% by weight of the water-soluble fibrous non-woven sheet.

The water-soluble fibrous non-woven sheet may exhibit different regions, such as different regions of basis weight, density, and/or caliper. The water-soluble fibrous non-woven sheet may comprise texture on one or more of its surfaces. A surface of the water-soluble fibrous non-woven sheet may comprise a pattern, such as a non-random, repeating pattern. The water-soluble fibrous non-woven sheet may have a thickness between 0.01 mm and 100 mm, preferably between 0.05 mm and 50 mm, more preferably between 0.1 mm and 20 mm, even more preferably between 0.1 mm and 10 mm, even more preferably between 0.1 mm and 5 mm, even more preferably between 0.1 mm and 2 mm, even more preferably between 0.1 mm and 0.5 mm, most preferably between 0.1 mm and 0.3 mm. Those skilled in the art will be aware of standard methods to measure the thickness.

The fibers may comprise a polyvinyl alcohol polymer. Preferably, the fibers comprise between 50% and 98%, preferably between 65% and 97%, more preferably between 80% and 96%, even more preferably between 88% and 96% by weight of the fiber of polyvinyl alcohol.

The polyvinyl alcohol polymer may have a weight average molecular weight of between 50 kDa and 150 kDa, preferably between 75 kDa and 140 kDa, more preferably between 100 kDa and 130 kDa. “Weight average molecular weight” as used herein means the weight average molecular weight as determined using gel permeation chromatography. Those skilled in the art will be aware of other known techniques to determine the weight average molecular weight (MW).

Preferably, the polyvinyl alcohol polymer is a polyvinyl alcohol homopolymer. Preferably, the polyvinyl alcohol homopolymer has an average percentage degree of hydrolysis of from 75% to 100%, preferably of from 80% to 95%, most preferably of from 85% to 90%. Preferably, the polyvinyl alcohol homopolymer has an average viscosity of from 1 to 30 mPas, preferably from 5 to 25 mPas, most preferably from 10 to 20 mPas, wherein the viscosity is measured as a 4% aqueous solution in demineralized water at 20° C.

The fibers preferably comprise between 0.1% and 15% by weight of the fibers of a gel-breaker, wherein the gel-breaker is selected from polyols, sugar alcohols, amines, amides, carbohydrates, multivalent cations, or a mixture thereof, preferably polyols, sugar alcohols or a mixture thereof. Preferably, the fibers comprise between 1% and 12%, preferably between 2% and 10% by weight of the fibers of the gel-breaker.

Typically, the granular laundry composition is a fully formulated laundry composition, not a portion thereof such as a spray-dried, extruded or agglomerate particle that only forms part of the laundry composition. Typically, the granular laundry composition comprises a plurality of chemically different particles, such as spray-dried base detergent particles and/or agglomerated base detergent particles and/or extruded base detergent particles, in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

Suitable laundry compositions comprise a detergent ingredient selected from: detersive surfactant, such as anionic detersive surfactants, non-ionic detersive surfactants, cationic detersive surfactants, zwitterionic detersive surfactants and amphoteric detersive surfactants; polymers, such as carboxylate polymers, soil release polymer, anti-redeposition polymers, cellulosic polymers and care polymers; bleach, such as sources of hydrogen peroxide, bleach activators, bleach catalysts and pre-formed peracids; photobleach, such as zinc and/or aluminium sulphonated phthalocyanine; enzymes, such as proteases, amylases, cellulases, lipases; zeolite builder; phosphate builder; co-builders, such as citric acid and citrate; carbonate, such as sodium carbonate and sodium bicarbonate; sulphate salt, such as sodium sulphate; silicate salt such as sodium silicate; chloride salt, such as sodium chloride; brighteners; chelants; hueing agents; dye transfer inhibitors; dye fixative agents; perfume; silicone; fabric softening agents, such as clay; flocculants, such as polyethyleneoxide; suds supressors; and any combination thereof.

In a first aspect of the present invention, the granular laundry composition comprises a surfactant and dipicolinic acid or salts thereof, wherein the composition comprises a first particle, characterized in that the first particle comprises the surfactant and the dipicolinic acid or salts thereof.

Laundry detergent compositions produce certain amount of suds that are useful in distributing the product uniformly across the fabric to be washed. The amount of suds is normally limited by the amount of anionic surfactant that can safely and feasibly be added to the composition.

It was surprisingly found that the co-formulation of dipicolinic acid with a surfactant into a single particle provides an enhanced sudsing effect compared to when dipicolinic acid powder is dry-mixed to surfactant particles.

Without wishing to be bound by theory, the sudsing benefits provided by the co-formulation of the surfactant and the dipicolinic acid are due to a maximized surface contact and an excellent mixing and dissolution of the two ingredients before being co-granulated into a particle. Another important factor might be an optimized rate of release of dipicolinic acid from the above particle compared to rate of release of dipicolinic acid from dipicolinic acid powder.

In a preferred aspect of the present invention, the granular laundry composition may have a pH in use of the composition of at least 9, preferably between 10 and 10.5, wherein the pH in use of the composition is measured at a temperature of 20° C. and at a concentration of 1 g/l in deionized water. The skilled person will be aware of how to use a pH meter to measure the pH of a solution. Without wishing to be bound by theory, a pH of at least 9 will allow an efficient activity of bleach, a common component of granular laundry compositions, thus enhancing the whitening and stain removal activity of the composition.

It is known that, in hard surface cleaning detergents, dipicolinic acid maintains suds stability in soft and hard water, when combined with a surfactant and with 0.5% to 30% of magnesium salts. It was surprisingly found that the present invention provided a sudsing benefit with less than 0.5% magnesium salts.

In one aspect of the present invention, the granular laundry composition may comprise between 0% and 20%, or even between 0% and 2%, or even between 0% and 0.5% by weight of the composition, of magnesium salts. The composition may even be substantially free of magnesium salts.

Suitable magnesium salts might be inorganic and/or organic magnesium salts, having a solubility product of at least 5×10⁻⁵. Suitable examples of inorganic magnesium salts are magnesium sulphate, magnesium chloride, magnesium bromide, magnesium iodide and magnesium nitrate, and suitable examples of organic magnesium salts are magnesium citrate and magnesium tartrate, and the magnesium salt(s) of EDTA.

In a preferred aspect of the present invention, the granular laundry composition may comprise between 0.01% and 4%, by weight of the composition, of water. Without wishing to be bound by theory, a higher weight percentage of water would increase the stickiness of the granular laundry composition leading to caking and clumping in the manufacturing machines tubing. This phenomenon would affect the handling and processability of the granular laundry composition during manufacturing. Moreover, an excessive presence of water might favor microbiological growth within the composition affecting shelf life and long-term stability.

In a preferred aspect of the present invention, the granular laundry composition may comprise an adjunct ingredient, wherein the adjunct ingredient is selected from the group comprising an amine, a surfactant system, a water-binding agent, a sulfite, fatty acids and/or salts thereof, enzymes, encapsulated benefit agents, soil release polymers, hueing agents, builders, chelating agents, dye transfer inhibiting agents, dispersants, enzyme stabilizers, catalytic materials, bleaching agents, bleach catalysts, bleach activators, soil removal/anti-redeposition agents, polymeric dispersing agents, polymeric grease cleaning agents, brighteners, suds suppressors, dyes, perfumes, encapsulated perfumes, a perfume delivery system, structure elasticizing agents, fabric softening agents, carriers, fillers, hydrotropes, organic solvents, anti-microbial agents and/or preservatives, neutralizers and/or pH adjusting agents, processing aids, fillers, rheology modifiers or structurants, opacifiers, pearlescent agents, pigments, anti-corrosion and/or anti-tarnishing agents, and mixtures thereof.

Suitable enzymes include lipases, proteases, cellulases, amylases and any combination thereof.

Suitable proteases include metalloproteases and/or serine proteases. Examples of suitable neutral or alkaline proteases include: subtilisins (EC 3.4.21.62); trypsin-type or chymotrypsin-type proteases; and metalloproteases. The suitable proteases include chemically or genetically modified mutants of the aforementioned suitable proteases.

Suitable amylases are derived from AA560 alpha amylase endogenous to Bacillus sp. DSM 12649, preferably having the following mutations: R118K, D183*, G184*, N195F, R320K, and/or R458K.

Suitable cellulases include those of bacterial or fungal origin. Chemically modified or protein engineered mutants are also suitable. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum.

Suitable lipases include those of bacterial, fungal or synthetic origin, and variants thereof. Chemically modified or protein engineered mutants are also suitable. Examples of suitable lipases include lipases from Humicola (synonym Thermomyces), e.g., from H. lanuginosa (T. lanuginosus).

In one aspect, the lipase is a first-wash lipase, preferably a variant of the wild-type lipase from Thermomyces lanuginosus comprising T231R and/or N233R mutations.

Other suitable enzymes are bleaching enzymes, such as peroxidases/oxidases, which include those of plant, bacterial or fungal origin and variants thereof. Other suitable enzymes include pectate lyases

A suitable soil release polymer has a structure as defined by one of the following structures (I), (II) or (III):

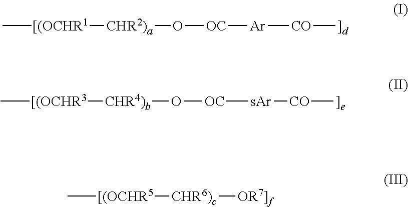

wherein:
a, b and c are from 1 to 200; d, e and f are from 1 to 50; Ar is a 1,4-substituted phenylene;
sAr is 1,3-substituted phenylene substituted in position 5 with SO₃Me; Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof; R¹, R², R³, R⁴, R⁵ and R⁶ are independently selected from H or C₁-C₁₈ n- or iso-alkyl; and R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group. Suitable soil release polymers are sold by Clariant under the TexCare® series of polymers, e.g. TexCare® SRN240 and TexCare® SRA300. Other suitable soil release polymers are sold by Solvay under the Repel-o-Tex® series of polymers, e.g. Repel-o-Tex® SF2 and Repel-o-Tex® Crystal.

Suitable hueing agents include small molecule dyes, typically falling into the Colour Index (C.I.) classifications of Acid, Direct, Basic, Reactive (including hydrolysed forms thereof) or Solvent or Disperse dyes, for example classified as Blue, Violet, Red, Green or Black, and provide the desired shade either alone or in combination. Preferred such hueing agents include Acid Violet 50, Direct Violet 9, 66 and 99, Solvent Violet 13 and any combination thereof.

Many hueing agents are known and described in the art which may be suitable for the present invention, such as hueing agents.

Suitable hueing agents include phthalocyanine and azo dye conjugates.

Suitable hueing agents may be alkoxylated. Such alkoxylated compounds may be produced by organic synthesis that may produce a mixture of molecules having different degrees of alkoxylation. Such mixtures may be used directly to provide the hueing agent, or may undergo a purification step to increase the proportion of the target molecule. Suitable hueing agents include alkoxylated bis-azo dyes, and/or alkoxylated thiophene azo dyes.

The hueing agent may be incorporated into the detergent composition as part of a reaction mixture which is the result of the organic synthesis for a dye molecule, with optional purification step(s). Such reaction mixtures generally comprise the dye molecule itself and in addition may comprise un-reacted starting materials and/or by-products of the organic synthesis route. Suitable hueing agents can be incorporated into hueing dye particles.

Suitable bleach includes sources of hydrogen peroxide, bleach activators, bleach catalysts, pre-formed peracids and any combination thereof. A particularly suitable bleach includes a combination of a source of hydrogen peroxide with a bleach activator and/or a bleach catalyst.

Suitable sources of hydrogen peroxide include sodium perborate and/or sodium percarbonate.

Suitable bleach activators include tetra acetyl ethylene diamine and/or alkyl oxybenzene sulphonate.

The composition may comprise a bleach catalyst. Suitable bleach catalysts include oxaziridinium bleach catalysts, transition metal bleach catalysts, especially manganese and iron bleach catalysts. A suitable bleach catalyst has a structure corresponding to general formula below:

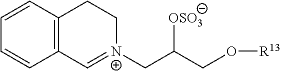

wherein R¹³ is selected from the group consisting of 2-ethylhexyl, 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl.

Suitable anti-redeposition polymers include polyethylene glycol polymers and/or polyethyleneimine polymers.

Suitable polyethylene glycol polymers include random graft co-polymers comprising: (i) hydrophilic backbone comprising polyethylene glycol; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide unit can be less than 0.02, or less than 0.016, the average number of graft sites per ethylene oxide unit can be in the range of from 0.010 to 0.018, or the average number of graft sites per ethylene oxide unit can be less than 0.010, or in the range of from 0.004 to 0.008. A suitable polyethylene glycol polymer is Sokalan HP22.

Suitable perfumes comprise perfume materials selected from the group: (a) perfume materials having a C log P of less than 3.0 and a boiling point of less than 250° C. (quadrant 1 perfume materials); (b) perfume materials having a C log P of less than 3.0 and a boiling point of 250° C. or greater (quadrant 2 perfume materials); (c) perfume materials having a C log P of 3.0 or greater and a boiling point of less than 250° C. (quadrant 3 perfume materials); (d) perfume materials having a C log P of 3.0 or greater and a boiling point of 250° C. or greater (quadrant 4 perfume materials); and (e) mixtures thereof.

It may be preferred for the perfume to be in the form of a perfume delivery technology. Such delivery technologies further stabilize and enhance the deposition and release of perfume materials from the laundered fabric. Such perfume delivery technologies can also be used to further increase the longevity of perfume release from the laundered fabric. Suitable perfume delivery technologies include: perfume microcapsules, pro-perfumes, polymer assisted deliveries, molecule assisted deliveries, fiber assisted deliveries, amine assisted deliveries, cyclodextrin, starch encapsulated accord, zeolite and other inorganic carriers, and any mixture thereof.

Suitable encapsulated perfumes may comprise a material selected from the group consisting of a perfume raw material and/or optionally a material selected from the group consisting of vegetable oil, including neat and/or blended vegetable oils including caster oil, coconut oil, cottonseed oil, grape oil, rapeseed, soybean oil, corn oil, palm oil, linseed oil, safflower oil, olive oil, peanut oil, coconut oil, palm kernel oil, castor oil, lemon oil and mixtures thereof; esters of vegetable oils, esters, including dibutyl adipate, dibutyl phthalate, butyl benzyl adipate, benzyl octyl adipate, tricresyl phosphate, trioctyl phosphate and mixtures thereof; straight or branched chain hydrocarbons, including those straight or branched chain hydrocarbons having a boiling point of greater than about 80° C.; partially hydrogenated terphenyls, dialkyl phthalates, alkyl biphenyls, including monoisopropylbiphenyl, alkylated naphthalene, including dipropylnaphthalene, petroleum spirits, including kerosene, mineral oil and mixtures thereof, aromatic solvents, including benzene, toluene and mixtures thereof; silicone oils; and mixtures thereof.

Suitable perfume delivery systems may take the form of a polymer-assisted delivery system. Such perfume delivery systems may take the form of an encapsulate, for example a core-shell encapsulate, where the core comprises perfume raw materials and is surrounded by a polymeric shell. The polymeric shell may comprise polymeric material derived from polyacrylates, polyurea, polyurethanes, polysaccharides, polyvinyl alcohol, melamine, derivatives thereof, or combinations thereof. Additionally or alternatively, suitable perfume delivery systems may include known pro-perfume/pro-fragrance materials.

### Dipicolinic Acid

Dipicolinic acid (pyridine-2,6-dicarboxylic acid or PDC and DPA) has a formula as shown below:

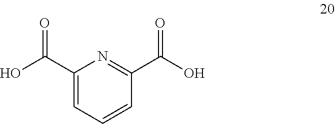 [SMILES: O=C(O)c1cccc(C(=O)O)n1]

The dipicolinic acid may have different forms depending on the dissociation status of its carboxylic acid groups: fully protonated as shown above, partially protonated (one negative charge), or fully unprotonated (two negative charges). Salts of dipicolinic acid (also known as dipicolinate) might be formed by the coordination between the negative charges of the unprotonated carboxyilic acids and positively charged counterions. Suitable positively charged counterions are selected from sodium salts, potassium salts, calcium salts, magnesium salts, hydrochloride salts, or mixtures thereof, preferably sodium salts. Those skilled in the art will be aware of other suitable positively charged counterions.

The term dipicolinic acid is not limited to the acid (protonated) form but should be extended in its interpretation to dipicolinic acid in the acid (protonated) form, to dipicolinic acid in the partially and/or fully unprotonated forms, to salts of dipicolinic acid or to mixtures thereof.

In a preferred aspect of the present invention, the dipicolinic acid or salts thereof may be present between 0.5% and 90%, preferably between 0.5% and 31%, more preferably between 1% and 5%, by weight of the first particle. The dipicolinic acid may even be present between 0.5% and 5%, or even between 0.5% and less than 3%, by weight of the first particle.

Without wishing to be bound by theory, the intimate contact and mixing of dipicolinic acid with the surfactant to form the first particle allows for a low concentration of dipicolinic acid to produce the desired effects. A low concentration of dipicolinic acid (between 1% and 5% by weight of the particle) might be advantageous over a high concentration (up to 90% by weight of the particle) as it will leave more flexibility in adding other active ingredients as part of the particle, thus potentially yielding additional benefits.

The dipicolinic acid may be present between 0.1% and 40%, preferably between 0.5% and 20%, more preferably between 0.5% and 10%, most preferably between 1% and 5%, by weight of the composition.

### Surfactants

Surfactants should be understood as detersive surfactants. Suitable detersive surfactants include anionic detersive surfactants, non-ionic detersive surfactant, cationic detersive surfactants, zwitterionic detersive surfactants and amphoteric detersive surfactants. Suitable detersive surfactants may be linear or branched, substituted or un-substituted, and may be derived from petrochemical material or biomaterial. Suitable and preferred surfactants will be discussed in more details below.

Suitable anionic detersive surfactants include sulphonate and sulphate detersive surfactants.

Suitable sulphonate detersive surfactants include methyl ester sulphonates, alpha olefin sulphonates, alkyl benzene sulphonates, especially alkyl benzene sulphonates, preferably C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, other suitable LAB include high 2-phenyl LAB, such as those supplied by Sasol under the tradename Hyblene®.

Suitable sulphate detersive surfactants include alkyl sulphate, preferably C₈₋₁₈ alkyl sulphate, or predominantly C₁₂ alkyl sulphate.

A preferred sulphate detersive surfactant is alkyl alkoxylated sulphate, preferably alkyl ethoxylated sulphate, preferably a C₈₋₁₈ alkyl alkoxylated sulphate, preferably a C₈₋₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈₋₁₈ alkyl ethoxylated sulphate having an average degree of ethoxylation of from 0.5 to 10, preferably from 0.5 to 5, more preferably from 0.5 to 3 and most preferably from 0.5 to 1.5.

The alkyl sulphate, alkyl alkoxylated sulphate and alkyl benzene sulphonates may be linear or branched, substituted or un-substituted, and may be derived from petrochemical material or biomaterial. Other suitable anionic detersive surfactants include alkyl ether carboxylates.

Suitable anionic detersive surfactants may be in salt form, suitable counter-ions include sodium, calcium, magnesium, amino alcohols, and any combination thereof. A preferred counter-ion is sodium.

Suitable non-ionic detersive surfactants are selected from the group consisting of: C₈-C₁₈ alkyl ethoxylates, such as, NEODOL® non-ionic surfactants from Shell; C₆-C₁₂ alkyl phenol alkoxylates wherein preferably the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; alkylpolysaccharides, preferably alkylpolyglycosides; methyl ester ethoxylates; polyhydroxy fatty acid amides; ether capped poly(oxyalkylated) alcohol surfactants; and mixtures thereof.

Suitable non-ionic detersive surfactants are alkylpolyglucoside and/or an alkyl alkoxylated alcohol.

Suitable non-ionic detersive surfactants include alkyl alkoxylated alcohols, preferably C₈₋₁₈ alkyl alkoxylated alcohol, preferably a C₈₋₁₈ alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C₈₋₁₈ alkyl ethoxylated alcohol having an average degree of ethoxylation of from 1 to 10, preferably from 1 to 7, more preferably from 1 to 5 and most preferably from 3 to 7. The alkyl alkoxylated alcohol can be linear or branched, and substituted or un-substituted.

Suitable nonionic detersive surfactants include secondary alcohol-based detersive surfactants.

Suitable cationic detersive surfactants include alkyl pyridinium compounds, alkyl quaternary ammonium compounds, alkyl quaternary phosphonium compounds, alkyl ternary sulphonium compounds, and mixtures thereof.

Preferred cationic detersive surfactants are quaternary ammonium compounds having the general formula:

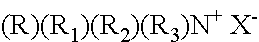

wherein, R is a linear or branched, substituted or unsubstituted C₆₋₁₈ alkyl or alkenyl moiety, R¹ and R² are independently selected from methyl or ethyl moieties, R³ is a hydroxyl, hydroxymethyl or a hydroxyethyl moiety, X is an anion which provides charge neutrality, preferred anions include: halides, preferably chloride; sulphate; and sulphonate.

Suitable zwitterionic detersive surfactants include amine oxides and/or betaines.

In a preferred aspect of the present invention, the surfactant may be present between 5% and 99%, preferably between 5% and less than 50%, more preferably between 8% and 25%, by weight of the first particle.

In a preferred aspect of the present invention, the surfactant may be selected from an anionic surfactant, a non-ionic surfactant, a cationic surfactant, a zwitterionic surfactant or mixtures thereof, preferably wherein the surfactant is an anionic surfactant. Without wishing to be bound by theory, the invention may work with different types of surfactants, however the presence of an anionic surfactant in co-formulation with dipicolinic acid increases the sudsing properties of the formulation.

The anionic surfactant may be selected from a linear alkyl sulfate, a branched alkyl sulfate, an alkoxylated alkyl sulfate, a methyl ester sulfonate, a linear alkyl benzene sulfonate, or mixtures thereof, preferably a linear alkyl benzene sulfonate.

Suitable linear alkyl sulfates may be C8-18 linear alkyl sulfates, preferably C12-14 linear alkyl sulfates.

Suitable branched alkyl sulfates may have a formula as shown below:

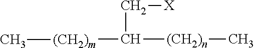

wherein X is a sulfate group, wherein m is greater than or equal to 0 and n is less than or equal to 16, preferably wherein m is between 6 and 11 and n is between 0 and 5.

Suitable alkoxylated alkyl sulfates may be C12-18 alkoxylated alkyl sulfates, more preferably C12-15 alkoxylated alkyl sulfates.

The methyl ester sulfonate is preferably a C16-18 methyl ester sulfonate.

The linear alkyl benzene sulfonate is preferably a C10-13 linear alkyl benzene sulfonate.

### Particles

The granular laundry composition comprises a first particle means that there can be a second, a third or even more particles, as long as the first particle comprises the surfactant and the dipicolinic acid or salts thereof.

The first particle may be present between 1% and 99%, by weight of the composition.

In a preferred aspect of the present invention, the first particle may be present between 40% and 80%, more preferably between 40% and 60%, by weight of the composition.

In a preferred aspect of the present invention, the first particle may have a density between 0.1 g/cm3 and 1.5 g/cm³, most preferably between 0.3 g/cm3 and 0.9 g/cm3. The skilled person will be aware of common methods for measuring the density of said particle. The first particle may be selected from the group comprising blown powders, agglomerates, extrudates, encapsulates, flakes, prills, pellets and mixtures thereof, more preferably agglomerates, blown powders and mixtures thereof, most preferably blown powders. The skilled person will be aware of common methods for producing these types of particles. Exemplified versions will be described later in the description.

Without wishing to be bound by theory, the first particle in the form of a blown powder possesses optimal physicochemical properties providing the best outcome in term of suds formation.

In another preferred aspect of the present invention, the composition may comprise between 0.1% and 4%, preferably between 1% and 4% by weight of the first particle, of water. Without wishing to be bound by theory, a higher weight percentage of water would increase the stickiness of the particles leading to caking and clumping in the machinery tubes. This phenomenon would affect the handling and processability of the particles during manufacturing. Moreover, an excessive presence of water in the particles might favor microbiological growth affecting the shelf life and the long-term stability of the composition.

In another aspect of the present invention, the first particle may comprise at least one inorganic material selected from carbonates, sulfates, chlorides, silicates or mixtures thereof, preferably wherein the at least one inorganic material comprises at least one counterion, more preferably wherein the at least one counterion is selected from the group comprising alkali metals or alkaline earth metals.

Preferably, the inorganic material is present between 1% to 90%, preferably between 20 to 60%, of the first particle.

Suitable carbonates may comprise carbonate salt. The first particle may comprise from 0 wt % to 70 wt % carbonate salt, or 5 wt % to 30 wt % carbonate salt. The first particle may even be substantially free of carbonate salt; substantially free means “no deliberately added”. Suitable carbonate salts include sodium carbonate and sodium bicarbonate. A preferred carbonate salts is sodium bicarbonate.

Suitable silicates may comprise silicate salt. The first particle may comprise from 0 wt % to 20 wt % silicate salt, or from 4 wt % to 15 wt % silicate salt. The first particle may even be substantially free of silicate salt; substantially free means “no deliberately added”. A preferred silicate salt is sodium silicate, especially preferred are sodium silicates having a Na₂O:SiO₂ weight ratio of from 1.0 to 2.8, preferably from 1.6 to 2.35.

Suitable sulphates may comprise a sulphate salt. The first particle may comprise from 0 wt % to 80 wt % sulphate salt, or from 30 wt % to 50 wt % sulphate salt. The first particle may even be substantially free of sulphate salt; substantially free means “no deliberately added”. A preferred sulphate salt is sodium sulphate.

Suitable chlorides may comprise a chloride salt. The first particle may comprise from 0 wt % to 80 wt % chloride salt, or from 30 wt % to 50 wt % chloride salt. The first particle may even be substantially free of chloride salt; substantially free means “no deliberately added”. A preferred chloride salt is sodium chloride.

Alkali metals are the elements of the first group of the periodic table such as Li, Na, K, Rb, Cs, Fr.

Alkaline earth metals are the elements of the second group of the periodic table such as Be, Mg, Ca, Sr, Ba, Ra.

The counterion may be preferably selected from Na, K, Mg or Ca.

It is to be understood that the counterion might also be an ammonium ion or any other ion that the skilled person deems suitable to be part of the inorganic material.

The term coordination means an ionic bond between a negative and a positive charge. In this aspect, the negative charge is carried by the disassociated form of carbonates, sulfates, chlorides, silicates or mixtures thereof and the positive charge is carried by the counterion.

### Consumer Product

In a second aspect, the present invention relates to a consumer product comprising a package and the composition according to the first aspect, wherein the package comprises at least one compartment, wherein the composition is contained in the at least one compartment.

The package contains at least one compartment means that it can contain a second, a third or even more compartments, as long as at least one compartment contains the composition of the present invention. The skilled person will be aware of suitable packages for the composition of the present invention. Exemplified versions of said package are described here.

The package may be plastic, fibre-based or a mixture thereof. Fibre-based package may comprise paperboard, corrugated board or a mixture thereof. Where the package comprises both plastic and fibre-based materials, preferably, the package comprises less than 10% by weight, or even less than 5% by weight of the package of fibre-based material. Such a ratio of plastic to fibre-based materials is preferred as such low plastic content allows the package to be placed in paper recycling streams within many countries.

The packaged product comprises a package. The package comprises an opening and at least one internal compartment in communication with the opening. The granular laundry composition is housed within the internal compartment. Preferably, the size of the opening is sufficient for the user to fit their hand through the opening and access the granular laundry composition housed within via the hand.

The package may comprise cellulose-containing materials, plastic, or a mixture thereof, preferably wherein the package comprises at least 50% by weight of the package of recycled materials. Preferably, a cellulose-containing material includes cardboard, corrugated cardboard, paperboard or a mixture thereof.

The package can be of any suitable shape and dimension. Those skilled in the art will be aware of suitable package size and dimensions. The pack may comprise elements such as handles and closures. If the pack comprises a closure, it may be a recloseable lid such as a hinged lid, screw lid or removeable lid. The pack may comprise a child resistant or child impeding closure or other latching or locking means. Those skilled in the art will be aware of suitable means.

Said package may comprise a dosing means for dispensing the granular laundry composition from a package to a laundry washing machine (or laundry wash basin in hand washing applications). The user may use the dosing means to meter the recommended unit dose amount or simply use the dosing means to meter the granular laundry composition according to the user's own preference. Examples of a dosing means may be a dispensing cap, dome, or the like, that is functionally attached to the package. The dosing means can be releasably detachable from the package and re-attachable to the package, such as for example, a cup mountable on the package. The dosing means may be tethered (e.g., by hinge or string) to the rest of the package (or alternatively un-tethered). The dosing means may have one or more demarcations (e.g., fill-line) to indicate a recommended unit dose amount. The packaging may include instructions instructing the user to open the removable opening of the package, and dispense (e.g. pour) the granular laundry composition contained in the package into the dosing means. Thereafter, the user may be instructed to dose the granular laundry composition in the dosing means to a laundry washing machine or laundry wash basin. The granular laundry composition of the present invention may be used to add freshness to laundry. The package including the dosing means may be made of plastic.

### Process of Laundering Fabrics

In a third aspect, the present invention relates to a process of laundering fabrics, said process comprising the steps of: A) obtaining at least one fabric to be washed and a wash liquor; and B) bringing the at least one fabric and the wash liquor into contact with one another, wherein the wash liquor comprises the composition according to the first aspect and water, wherein the water has a hardness between 0° D and 28.77°D, preferably between 4.80° D and 19.18° D, more preferably between 6.71°D and 14.39°D.

The water hardness is measured through the test methods described below.

The process of laundering fabric comprises the step of contacting the granular laundry composition to water to form a wash liquor, and laundering fabric in said wash liquor. Typically, the wash liquor has a temperature of above 0° C. to 90° C., or to 60° C., or to 40° C., or to 30° C., or to 20° C. The fabric may be contacted to the water prior to, or after, or simultaneous with, contacting the granular laundry composition with water. Typically, the wash liquor is formed by contacting the granular laundry composition to water in such an amount so that the concentration of granular laundry composition in the wash liquor is from 0.2 g/l to 20 g/l, or from 0.5 g/l to 10 g/l, or to 5.0 g/l. The method of laundering fabric can be carried out in a front-loading automatic washing machine, top loading automatic washing machines, including high efficiency automatic washing machines, or suitable hand-wash vessels. Typically, the wash liquor comprises 90 litres or less, or 60 litres or less, or 15 litres or less, or 10 litres or less of water. Typically, 200 g or less, or 150 g or less, or 100 g or less, or 50 g or less of granular laundry composition is contacted to water to form the wash liquor.

### Process of Making the Composition

In a fourth aspect, the present invention relates to a process of making the composition according to the first aspect, said process comprising the steps of: A) mixing dipicolinic acid, a surfactant and water to create a slurry; and B) drying the slurry to obtain a first particle.

Without wishing to be bound by theory, certain components of granular laundry compositions such as surfactants and silicates absorb moisture from the air (hygrosensitivity) resulting in higher cohesion of the particles, transitioning into an amorphous state. This state reduces the flowability of the particles causing issues during manufacturing such as caking and clumping in machinery tubes. Moreover, a reduced efficacy in use can be observed after long term storage in humid environments. It is believed that particles containing dipicolinic acid and surfactants surprisingly display a lower hygrosensitivity and potentially carry benefits in terms of handling, processability and long-term stability. Without wishing to be bound by theory, dipicolinic acid might create a shield around the particles preventing ambient water from entering the particles. Alternatively, dipicolinic acid might directly absorb ambient water preventing it from reaching sensitive ingredients such as surfactants or silicates.

Without wishing to be bound by theory, concentrated granular laundry compositions that are fast-dissolving and low density commonly demand a high use of energy, in the form of heat, to dry the product during spray-drying.

By adding dipicolinic acid in the spray-dried particles together with other surfactants, we surprisingly observe a significant improvement in the drying efficiency of the spray-dried particles, thus reducing the energy use associated with its manufacturing.

The skilled person will be aware of granulation methods and respective processing steps for producing granular laundry products. Exemplified versions are explained here:

Dipicolinic acid may be mixed with linear alkyl benzene sulphonate and an inorganic material such as an alkali metal salt. The mixture may contain 0.1-20 wt %, most preferably 0.5-5 wt %, dipicolinic acid, and 5-50 wt %, most preferably 8-30 wt % of linear alkyl benzene sulphonate, on a dry basis. The alkali metal salt may be added as a filler balance material.

Optionally, additional materials can be added to the blend, including but not exclusive to: silicic acid alkali metal salts, alkali metal hydroxides, maleic/acrylic acid salts, water, metal carbonates and/or dyes. The blend can be manufactured in a batch or continuous mixer tank. Preferably a batch mixer tank is used.

Dipicolinic acid may be added to the mixer or crutcher immediately after water is added but before the metal carbonates. Preferably, the following order of addition is followed: linear alkyl benzene sulphonate, dipicolinic acid, rest of liquid raw materials, metal carbonates, filler balance materials.

The liquid blend may go through a solidification process. Suitable solidification processes include but are not exclusive to spray-drying, drum-drying, agglomeration, prilling, coating, spray-congealing & extruding. Preferably, spray-drying is used.

After solidification, material is taken to a particle size in the range of 50-1600 μm, by size classification, sieving, attrition, fragmentation, milling &/or agglomeration. Subsequently and optionally, the particle can be dry-mixed with powder additives comprising but not limited to: enzymes, optical brighteners, polymers, fillers, flow aid, dispensing aid, aesthetics, perfumes and/or other active-containing particles. Lastly and optionally, the resulting powder mixture can be loaded with small quantities of actives and/or perfumes in liquid form, by spray-on process.

Typically, a suitable agglomeration process comprises the step of contacting a detersive ingredient, such as a detersive surfactant, e.g. linear alkyl benzene sulphonate and/or alkyl alkoxylated sulphate, with an inorganic material, such as sodium carbonate and/or silica, in a mixer. The agglomeration process may also be an in-situ neutralization agglomeration process wherein an acid precursor of a detersive surfactant, such as linear alkyl benzene sulphonate, is contacted with an alkaline material, such as carbonate and/or sodium hydroxide, in a mixer, and wherein the acid precursor of a detersive surfactant is neutralized by the alkaline material to form a detersive surfactant during the agglomeration process. Other suitable detergent ingredients that may be agglomerated include polymers, chelants, bleach activators, silicones and any combination thereof.

The agglomeration process may be a high, medium or low shear agglomeration process, wherein a high shear, medium shear or low shear mixer is used accordingly. The agglomeration process may be a multi-step agglomeration process wherein two or more mixers are used, such as a high shear mixer in combination with a medium or low shear mixer. The agglomeration process can be a continuous process or a batch process. It may be preferred for the agglomerates to be subjected to a drying step, for example to a fluid bed drying step. It may also be preferred for the agglomerates to be subjected to a cooling step, for example a fluid bed cooling step.

Typically, the agglomerates are subjected to particle size classification, for example a fluid bed elutriation and/or a sieve, to obtain the desired particle size distribution. Preferably, the agglomerates have a particle size distribution such that weight average particle size is in the range of from 300 micrometers to 800 micrometers, and less than 10 wt % of the agglomerates have a particle size less than 150 micrometers and less than 10 wt % of the agglomerates have a particle size greater than 1200 micrometers. It may be preferred for fines and over-sized agglomerates to be recycled back into the agglomeration process. Typically, over-sized particles are subjected to a size reduction step, such as grinding, and recycled back into an appropriate place in the agglomeration process, such as the mixer. Typically, fines are recycled back into an appropriate place in the agglomeration process, such as the mixer.

It may be preferred for ingredients such as polymer and/or non-ionic detersive surfactant and/or perfume to be sprayed onto base detergent particles, such as spray-dried base detergent particles and/or agglomerated base detergent particles. Typically, this spray-on step is carried out in a tumbling drum mixer.

In a preferred aspect of the present invention, the mixing may occur in a crutcher, wherein the drying may be heat-drying, preferably wherein the heat-drying is spray-drying, wherein the spray-drying transforms the slurry into a blown powder, preferably wherein the blown powder has a mean particle size between 0.1 mm and 1.8 mm, more preferably between 0.2 mm and 0.8 mm, most preferably between 0.3 mm and 0.6 mm, preferably wherein the heat-drying occurs in a heating tower.

Without wishing to be bound by theory, the spray-drying process is advantageous compared to other granulation processes as it provides improved physicochemical properties to the particles to provide the aforementioned benefits.

The skilled person will be aware of the functioning of crutchers for mixing ingredients for manufacturing granular laundry compositions.

Typically, a suitable heat-drying process is a drying process as above wherein heat is used as form of energy. The skilled person will be aware of suitable heat-drying process for producing said particles and of the functioning of heating towers. Preferably, the heating tower is a spray-drying tower.

Typically, a suitable spray-drying process comprises the step of forming an aqueous slurry mixture, transferring it through at least one pump, preferably two pumps, to a pressure nozzle. Atomizing the aqueous slurry mixture into a spray-drying tower and drying the aqueous slurry mixture to form spray-dried particles. Preferably, the spray-drying tower is a counter-current spray-drying tower, although a co-current spray-drying tower may also be suitable.

Typically, the spray-dried powder is subjected to cooling, for example an air lift. Typically, the spray-drying powder is subjected to particle size classification, for example a sieve, to obtain the desired particle size distribution. Preferably, the spray-dried powder has a particle size distribution such that weight average particle size is in the range of from 300 micrometers to 500 micrometers, and less than 10 wt % of the spray-dried particles have a particle size greater than 2360 micrometers.

It may be preferred to heat the aqueous slurry mixture to elevated temperatures prior to atomization into the spray-drying tower. It may be preferred for anionic surfactant, such as linear alkyl benzene sulphonate, to be introduced into the spray-drying process after the step of forming the aqueous slurry mixture: for example, introducing an acid precursor to the aqueous slurry mixture after the pump. It may be preferred for a gas, such as air, to be introduced into the spray-drying process after the step of forming the aqueous slurry. It may be preferred for any inorganic ingredients, such as sodium sulphate and sodium carbonate, if present in the aqueous slurry mixture, to be micronized to a small particle size.

### Test Methods

### Particle Density Determination

The skilled person will be aware of common methods to measure the density of particles as defined in this patent. An exemplified version of the test method used is the following:

The density of the particle as defined in this patent is the Apparent Bulk Density. The Apparent Bulk Density is defined as the mass of a sample divided by its total volume, which includes both the solid material and the void spaces between the particles. This method can be used for free-flowing materials. The material is freely poured through a funnel into a measuring cup of a known volume. By weighing the measuring cup empty and full, the Apparent Bulk Density is found. The steps of the procedure are the following:

The clean empty cup is weighed to the nearest 0.1 g and the tared cup is placed under the funnel. The funnel is closed at the bottom opening, holding the closure plate lightly against the funnel opening. The funnel is filled with the sample to the upper lip, and then the closure quickly opened, allowing the sample to run into and overflow the cup. The contents of the cup are carefully levelled with the straight edge, and then tapped gently to compact the powder which helps to avoid accidental spillage when weighing. The cup with sample is weighed to the nearest 0.1 g. Density measurements are made on grab samples. Once a grab sample has been removed from a carton, then the carton is no longer representative and cannot be used for quantitative analytical testing.

### Water Hardness Measurement

The skilled person will be aware of common methods to measure the hardness of water. An exemplified version of the test method use is the following:

The principle of this Test Method lies in the simple determination of water hardness (in terms of magnesium and/or calcium presence) via reaction with EDTA. The di-sodium salt of ethylenediamine-tetra-acetic acid (EDTA) forms stable complexes with calcium and magnesium ions. This property is used as the basis for simple volumetric determination of water hardness. The calcium/magnesium ions are titrated with EDTA using hardness indicators which themselves form coloured metallic complexes. The volume (mls) of EDTA required to induce this colour change is inserted into a standard calculation which will give the total (or calcium/magnesium) hardness of the water.

A clean 100 mL measuring cylinder is taken and used to remove a 50 mL sample of water for which the hardness must be determined.

The sample is placed in a porcelain mortar and added 1 total hardness indicator tablet (BDH Laboratory Supplies, Poole BH15 1TD Reagent D Prod 16023 2E), crushing it to ensure that it all dissolves. 5 drops of stock ammonia buffer solution are added (containing 15% w/v NH3), the solution is pink/red. The solution is titrated with 0.01M EDTA solution (from burette) until colour change from pink/red to clear blue is observed.

The EDTA titre is noted and the following equation is applied:

$$Water Hardness = \frac{Titre EDTA ( mL ) \times 1000}{mL water sample \times ppm {CaCO}_{3}}$$

| | Equivalent ppm CaCO₃ |
|---|---|
| English Degrees Clark | 14.29 |
| German Degree (°dH) | 17.86 |
| US grains per gallon | 17.15 |
| French Degrees | 10.00 |

### Reference: P779 the Water Encyclopedia Second Edition 1990 Frits Von Der Leeden

For a standard 50 mL water sample aliquot the above equation can be simplified as follows:

| | |
|---|---|
| Water hardness (Clark) | Titre EDTA (mL) × 1.40 |
| Water hardness (German) | Titre EDTA (mL) × 1.12 |
| Water hardness (US gpg) | Titre EDTA (mL) × 1.16 |
| Water hardness (French) | Titre EDTA (mL) × 2.00 |
| Water hardness (ppm CaCO₃) | Titre EDTA (mL) × 20 |

### EXAMPLES

### Example 1

A granular laundry composition, Powder A, was manufactured by spray-drying a particle with composition as shown in Table 1. This formulation is free of dipicolinic acid.

Separately, a granular laundry composition, Powder B, was manufactured by spray-drying a particle with composition as shown in Table 1. 97 parts of the spray-dried particle were then dry-admixed with 3 parts of powdered dipicolinic acid.

Lastly, a granular laundry composition, Powder C, was manufactured by spray-drying a particle comprising 3 wt % dipicolinic acid. The composition of Powder C is shown in Table 1.

TABLE 1
Composition of Powder A, Powder B & Powder C

| | | Powder A | Powder B | Powder C |
|---|---|---|---|---|
| Spray- | Linear Alkyl | 19.41% | 19.41% | 19.41% |
| Dried | Benzene Sulphonate | | | |
| Particle | Dipicolinic Acid | 0.00% | 0.00% | 3.00% |
| | Silicic Acid Alkali | 8.39% | 8.39% | 8.39% |
| | Sodium Salt | | | |
| | Maleic/Acrylic | 1.06% | 1.06% | 1.06% |
| | Acid Salt | | | |
| | Sodium Carbonate | 15.02% | 15.02% | 15.02% |
| | Dyes & Miscellaneous | 1.29% | 1.29% | 1.29% |
| | Water | 2.00% | 2.00% | 2.00% |
| | Sodium sulphate | 49.83% | 49.83% | 49.83% |
| | (filler balance | | | |
| | material) | | | |

| | | | |
|---|---|---|---|
| Dry-mixed Dipicolinic Acid | 0.00% | 3.00% | 0.00% |
| Dry-mixed Sodium sulphate | 3.00% | 0.00% | 0.00% |
| (filler balance material) | | | |

Powders A, B & C were dissolved in 500 ml of water with a hardness of 21.10° D, at 25° C., inside cylindrical containers of 29 cm height×9 cm diameter to prepare wash liquors with a concentration equivalent to 378 ppm of linear alkyl benzene sulphonate in all 3 cases.

The wash liquors in the cylindrical containers were tumbled at a constant rotational speed of 30 revolutions per minute, during time lapses.

After 180 seconds in the experiment, 160 microlitres of Technical Body Soil, a mixture of paraffin oils and fatty acids with composition shown in table 2, were added to each wash liquor, before tumbling resume for 4 more lapses. Finally, after 420 seconds of tumbling, an additional 320 microlitres of soil were added to each wash liquor and tumbling continued for another 10 lapses. The height of the suds generated inside the cylinder after each time lapse was recorded by measuring the distance between the water-foam interphase and the lowest point of concave meniscus formed at the top of the foam inside the cylinder. The height of the suds generated inside the cylinder after each time lapse was recorded and is reported in Table 3.

As it can be observed in Table 3, the suds height reached in Powder A is the lowest amongst the 3 products throughout the entire experiment. The delta values in the last two columns of table 3 represent the % increase in suds height when dipicolinic acid has been co-formulated in the same particle as the surfactant.

Surprisingly, the suds height achieved in Powder C during the later stages of the test (after soil addition) was higher than that achieved for Powder B, despite both recipes having identical composition.

TABLE 2
Composition of Technical Body soil

| | |
|---|---|
| Coconut Oil | 15% |
| Oleic Acid | 15% |
| Paraffin Oil | 15% |
| Olive Oil | 15% |
| Cottonseed Oil | 15% |
| Squalene | 5% |
| Cholesterol | 5% |
| Myristic Acid | 5% |
| Palmetic Acid | 5% |
| Stearic Acid | 5% |

TABLE 3
Suds height measured inside tumbling cylinder over different
time lapses, prior and after addition of Technical Body Soil

| | | | | | Delta | Delta |
|---|---|---|---|---|---|---|
| | Time | Powder | Powder | Powder | [Powder C − | [Powder C − |
| | lapse | A | B | C | Powder A] | Powder B] |
| | (seconds) | (cm) | (cm) | (cm) | (%) | (%) |
| No Technical | 0 | 0.0 | 0.0 | 0.0 | 0.0 | 0.0 |
| Body Soil | 60 | 6.4 | 6.6 | 6.9 | +7.8% | +6.1% |
| added | 120 | 7.0 | 7.5 | 7.4 | +5.7% | no difference |
| | 180 | 7.6 | 8.2 | 8.2 | +7.9% | no difference |
| 160 microlitres | 240 | 5.8 | 6.3 | 6.5 | +13.8% | +3.2% |
| of Technical | 300 | 6.1 | 6.4 | 6.9 | +13.1% | +7.8% |
| Body soil | 360 | 6.4 | 6.7 | 7.0 | +9.4% | +4.5% |
| added | 420 | 6.3 | 6.8 | 7.1 | +11.1% | +2.9% |
| 480 microlitres | 480 | 4.8 | 5.3 | 5.6 | +16.7% | +5.7% |
| of Technical | 540 | 5.2 | 5.5 | 6.0 | +15.4% | +9.1% |
| Body soil | 600 | 5.2 | 5.4 | 6.1 | +17.3% | +13.0% |
| added | 660 | 5.4 | 5.6 | 6.2 | +14.8% | +10.7% |
| | 720 | 5.3 | 5.6 | 6.1 | +15.1% | +7.1% |
| | 780 | 5.3 | 5.6 | 6.2 | +18.9% | +12.5% |
| | 840 | 5.3 | 5.7 | 6.2 | +17.0% | +8.8% |
| | 900 | 5.3 | 5.6 | 6.3 | +18.9% | +10.7% |
| | 960 | 5.3 | 5.8 | 6.3 | +18.9% | +8.6% |
| | 1020 | 5.2 | 5.5 | 6.1 | +17.3% | +10.9% |

### Example 2

A granular laundry composition, Powder D, was manufactured by spray-drying a particle with composition as shown in Table 4. This formulation is free of dipicolinic acid.

Separately, a granular laundry composition, Powder E, was manufactured by spray-drying a particle comprising 3 wt % dipicolinic acid. The composition of Powder E is shown in Table 4.

TABLE 4
Composition of Powder D & Powder E

| | | Powder D | Powder E |
|---|---|---|---|
| Spray- | Linear Alkyl Benzene Sulphonate | 19.41% | 19.41% |
| Dried | Dipicolinic Acid | 0.00% | 3.00% |
| Particle | Silicic Acid Alkali Sodium Salt | 8.39% | 8.39% |
| | Maleic/Acrylic Acid Salt | 1.06% | 1.06% |
| | Sodium Carbonate | 15.02% | 15.02% |
| | Dyes & Miscellaneous | 1.29% | 1.29% |
| | Water | 2.00% | 2.00% |
| | Sodium sulphate (filler balance | 49.83% | 49.83% |
| | material) | | |

| | | |
|---|---|---|
| Dry-mixed Sodium sulphate (filler balance | 3.00% | 0.00% |
| material) | | |

Both Powder D and Powder E were packed in identical cardboard boxes with total surface area of 1800 cm2 and a Moisture Vapour Transmission Rate of 50 g/m2/day. The Moisture Vapour Transmission Rate for the packaging material is determined via Dynamic Vapor Sorption. The skilled person is aware of methods to perform Dynamic Vapor Sorption of packaging materials. Each box was packed with 1500 grams of powder each. The boxes were then kept inside an oven conditioned at 32° C. and 80% Relative Humidity, for up to 7 days. One box at a time for Powder D and Powder E were removed from the oven every 7 hours and let to cool down and equilibrate with ambient temperature and humidity for 12 hours. Subsequently, each box was opened, and the flowability of the powders was inspected qualitatively, following the grading criteria shown in Table 5. The relative humidity of the powders was also measured. The skilled person is aware that the relative humidity is the technical term to describe free moisture in the powder sample.

TABLE 5
Grading scale for Powder Flowability

| | |
|---|---|
| Grade 10 | Free and steady flow like dry sand. No shaking or intervention required. |
| Grade 9 | Flows with slight hesitation but empties without shaking or intervention. |
| Grade 8 | Carton does not empty independently. Requires 1-2 shakes to recommence flow |
| | and empty the contents of the carton. |
| Grade 7 | Carton does not empty independently. Requires 3-5 shakes to recommence flow |
| | and empty the contents of the carton. |
| Grade 6 | Carton does not empty independently. Requires 6 or more shakes to empty the |
| | contents of the carton |
| Grade 5 | Carton does not empty independently. Continuous shaking is required to empty the |
| | contents of the carton |
| Grade 4 | Carton does not empty independently. Hammering on carton required as well as |
| | constant shaking to empty the contents of the carton |
| Grade 3 | Carton does not empty independently. Powder cannot be emptied from the carton |
| | in its entirety without opening carton to remove larger cakes. |
| Grade 2 | Carton does not empty independently. Entire contents of the carton are caked solid |
| | and there is no flow. |

At the end of the experiment, a plot for Flowability Grade vs. Powder Relative Humidity was created for both Powder D and E. As expected, the flowability worsens as the relative humidity of the powder increases. The relative humidity of the powder at which the flowability went below a threshold Grade=6 was computed, as a metric for hygrosensitivity. These values are reported in Table 6.

TABLE 6
Critical Equilibrium Relative Humidity
measured for Powder D & Powder E

| | Powder D | Powder E |
|---|---|---|
| Powder Equilibrium Relative Humidity | 43.40% | 52.64% |
| at which Flowability grade is >=6 | | |

As it can be observed in Table 6, the critical Equilibrium Relative Humidity for Powder E is significantly higher than Powder D, indicating Powder E is less hygrosensitive.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A granular laundry composition comprising a surfactant and dipicolinic acid or salts thereof,
wherein the composition comprises a first particle,
characterized in that the first particle comprises the surfactant and the dipicolinic acid or salts thereof.

2. The composition according to claim 1, wherein the dipicolinic acid or salts thereof are present at a level between about 0.5% and about 90% by weight of the first particle.

3. The composition according to claim 1, wherein pH in use of the composition is at least about 9, wherein the pH in use of the composition is measured at a temperature of about 20° C. and at a concentration of about 1 g/l in deionized water.

4. The composition according to claim 1, wherein the first particle is present at a level between about 40% and about 80% by weight of the composition.

5. The composition according to claim 1, wherein the surfactant is present at a level between about 5% and about 99% by weight of the first particle.

6. The composition according to claim 1, wherein the composition comprises between about 0.01% and about 4%, by weight of the composition, of water,
wherein the composition comprises between about 0.1% and about 4% by weight of the first particle, of water.

7. The composition according to claim 1, wherein the surfactant is selected from an anionic surfactant, a non-ionic surfactant, a cationic surfactant, a zwitterionic surfactant or mixtures thereof.

8. The composition according to claim 7, wherein the surfactant is an anionic surfactant.

9. The composition according to claim 8, wherein the anionic surfactant is selected from a linear alkyl sulfate, a branched alkyl sulfate, an alkoxylated alkyl sulfate, a methyl ester sulfonate, a linear alkyl benzene sulfonate, or mixtures thereof.

10. The composition according to claim 9, wherein the anionic surfactant is a linear alkyl benzene sulfonate.

11. The composition according to claim 10, wherein the linear alkyl benzene sulfonate is a C10-13 linear alkyl benzene sulfonate.

12. The composition according to claim 1, wherein the first particle further comprises at least one inorganic material selected from carbonates, sulfates, chlorides, silicates and mixtures thereof.

13. The composition according to claim 12, wherein the at least one inorganic material comprises at least one counterion, and wherein the at least one counterion is selected from the group of alkali metals and alkaline earth metals.

14. The composition according to claim 1, wherein the first particle has a density at a level between about 0.1 g/cm3 and about 1.5 g/cm3, wherein the first particle is selected from the group of blown powders, agglomerates, extrudates, encapsulates, flakes, prills, pellets and mixtures thereof.

15. The composition according to claim 1, wherein said composition further comprises an adjunct ingredient, wherein the adjunct ingredient is selected from the group of an amine, a surfactant system, a water-binding agent, a sulfite, fatty acids and/or salts thereof, enzymes, encapsulated benefit agents, soil release polymers, hueing agents, builders, chelating agents, dye transfer inhibiting agents, dispersants, enzyme stabilizers, catalytic materials, bleaching agents, bleach catalysts, bleach activators, soil removal/anti-redeposition agents, polymeric dispersing agents, polymeric grease cleaning agents, brighteners, suds suppressors, dyes, perfumes, encapsulated perfumes, a perfume delivery system, structure elasticizing agents, fabric softening agents, carriers, fillers, hydrotropes, organic solvents, anti-microbial agents and/or preservatives, neutralizers and/or pH adjusting agents, processing aids, fillers, rheology modifiers or structurants, opacifiers, pearlescent agents, pigments, anti-corrosion and/or anti-tarnishing agents, and mixtures thereof.

16. A consumer product comprising a package and the composition according to claim 1, wherein the package comprises at least one compartment, wherein the composition is contained in the at least one compartment.

17. A process of laundering fabrics, said process comprising the steps of:
A) obtaining at least one fabric to be washed and a wash liquor; and
B) bringing the at least one fabric and the wash liquor into contact with one another, wherein the wash liquor comprises the composition according to claim 1 and water, wherein the water has a hardness between about 0° D and about 28.77°D.

18. A process of making the composition according to claim 1, said process comprising the steps of:
A) mixing dipicolinic acid, a surfactant and water to create a slurry; and
B) drying the slurry to obtain the first particle.

19. The process according to claim 18,
wherein the mixing occurs in a crutcher,
wherein the drying is spray-drying, wherein the spray-drying transforms the slurry into a blown powder.

20. A process according to claim 19, wherein the blown powder has a mean particle size between about 0.1 mm and about 1.8 mm and wherein the spray-drying occurs in a heating tower.
